(19) United States
(12) Patent Application Publication
(10) Pub. No.: US 2006/0036904 A1
(43) Pub. Date: Feb. 16, 2006

(54) Data replication method over a limited bandwidth network by mirroring parities

(75) Inventor: Qing Yang, Saunderstown, RI (US)

Correspondence Address: EDWARDS & ANGELL, LLP, P.O. BOX 55874, BOSTON, MA, 02205, US

(73) Assignee: Gemini Storage

(21) Appl. No.: 10/971,470

(22) Filed: Oct. 22, 2004

Related U.S. Application Data
(60) Provisional application No. 60/601,535, filed on Aug. 13, 2004.

(51) Int. Cl. G06F 11/00

(52) U.S. Cl. 714/7

(57) ABSTRACT

A storage architecture provides efficient remote mirroring of data in RAID storage or like to a remote storage through a network connection. The storage architecture mirrors only a delta_parity. A parity cache keeps the delta_parity of each data block until the block is mirrored to the remote site. Whenever network bandwidth is available, the parity cache performs a cache operation to mirror the delta_parity to the remote site. If a cache miss occurs, i.e. the delta_parity is not found in the parity cache, computation of the data parity creates the delta_parity. For RAID architectures, reading old data and old parity is a necessary step of computing new parity for every write operation. Thus, no additional operation is needed to compute the delta_parity for mirroring. At the remote site, the delta_parity is used to generate the new parity and the new data using the old data and parity and, in turn, WAN traffic is substantially reduced.

### CROSS-REFERENCE TO RELATED APPLICATION

This application claims priority to U.S. Provisional Patent Application No. 60/601,535, filed Aug. 13, 2004, which is incorporated herein by reference.

### BACKGROUND OF THE INVENTION

1. Field of the Invention

The subject disclosure relates to methods and systems for mirroring/replicating information in a limited bandwidth distributed computing network, and more particularly to replicating/mirroring data while minimizing communication traffic and without impacting application performance in a redundant array of independent disks (RAID) array.

2. Background of the Related Art

Remote data replication or archiving data has become increasingly important as organizations and businesses depend more and more on digital information. Loss of data at the primary storage site, for any reason, has become an unacceptable business risk in the information age. Since the tragic events of Sep. 11, 2001, replicating data to a remote storage back-up site has taken on new urgency as a result of heightened awareness of business resiliency requirements. Remote data replication is widely deployed in industry as varied as finance, legal and other corporate settings for tolerating primary failures and disaster recovery. Consequently, many products have been developed to provide remote replication or mirroring of data.

One type of remote replication product is block-level remote mirroring for data storage in fiber channel storage area networks (FC-SAN). Block-level remote mirroring is typically done through dedicated or leased network connections (e.g., WAN connection) and managed on a storage area network based on FC-SAN. EMC Corporaton of Hopkinton, Mass. offers such a product know as the Symmetrix Remote Data Facility

In particular, use of RAID disk drives has also been widely used to reliably store data for recovery upon failure of the primary storage system. However, replicating data to a geographically remote site demands high network bandwidth on a wide area network (WAN). It is well-known that high bandwidth WAN connections such as leased lines of tens or hundreds of megabytes are very costly. As such, use of such communication networks is limited to companies that can afford the expense. In order to enable remote data replication over commodity Internet connections, a number of technologies have emerged in the storage market. These technologies can be generally classified into three categories: WAN acceleration using data compressions; backup changed data blocks (delta-blocks); and backup changed bytes using byte-patching techniques.

Compression attempts to maximize data density resulting in smaller amounts of data to be transferred over networks. There are many successful compression algorithms including both lossless and lossy compressions. Compression ratio ranges from 2 to 20 depending on the patterns of data to be compressed. While compression can reduce network traffic to a large extent, the actual compression ratio depends greatly on the specific application and the specific file types. Although relative lightweight real-time compression algorithms have had great success in recent years, there are factors working against compression algorithms as a universal panacea for data storage. These factors include high computational cost, high latency, application or file system dependency, and limited compression ratio for lossless data compression. There are also technologies that replicate or mirror changed data in a file reducing network traffic. These technologies work at a file system level. The draw back of technologies working at the file server level is that they are server intrusive because installation is required in the file system of the server. As a result, the limited resources of the server (such as CPU, RAM, and buses that are needed to run applications) are consumed. In addition, such file system level technologies are file system dependent.

Mirroring changed data blocks (i.e. delta-blocks) reduces the network traffic because only changed blocks are replicated over the network. Patching techniques find the changed data between the old version and the new version of a file by performing a bit-wise exclusive OR operation. While these approaches can reduce network traffic, significant overhead is incurred while collecting the changes. To back up changed data blocks, the system has to keep track of meta-data and to collect changed blocks from disks upon replication. To back up changed bytes of a file, a process of generating a patch and comparing the new file with the old file, has to be initiated upon replication. The generation and comparison process takes a significant amount of time due to slow disk operations. Therefore, these technologies are generally used for periodical backups rather than real-time remote mirroring. The recovery time objective (RTO) and recovery point objective (RPO) are highly dependent on the backup intervals. If the interval is too large, the RPO becomes large increasing the chance of losing business data. If the interval is too small, delta collection overheads increase drastically slowing down application performance significantly.

The lower cost solutions also tend to have limited bandwidth and less demanding replication requirements. For example, the lower cost solutions are based on file system level data replication at predetermined time intervals such as daily. During replication, a specialized backup application program is invoked to collect file changes and transfer the changes to a remote site. Typically, the changes may be identified by review of file meta data to identify modified files. The modified files are then transmitted to the server program through TCP/IP socket so that the server program can update the changes in the backup file. It can be seen that such approaches are more efficient than backing up every file. However, data is vulnerable between scheduled backups and the backups themselves take an undesirably long amount of time to complete.

Several following examples, each of which is incorporated herein by reference in its entirety, disclose various approaches to parity computation in a disk array. U.S. Pat. No 5,341,381 has a parity cache to cache RRR-parity (remaining redundancy row parity) to reduce disk operations for parity computation in a RAID. U.S. Pat. No. 6,523,087 caches parity and checks for each write operation to determine if the new write is within the same stripe to make use of the cached parity. U.S. Pat. No. 6,298,415 caches sectors and calculates parity of the sectors in a strip in cache and reads from disks only those sectors not in cache thereby reducing disk operations. These prior art technologies try to minimize computation cost in a RAID system but do not solve the problem of communication cost for data replication across computer networks. U.S. Pat. No. 6,480,970 presents a method for speeding up the process of verifying and checking of data consistency between two mirrored storages located geographically remote places by transferring only a meta data structure and time stamp as opposed to data block itself. Although this prior art method aims at verifying and checking data consistency between mirrored storages, it does not consider solving efficiently transferring data over a network with limited bandwidth for data replication and remote mirroring.

In view of the above, a need exists for a method and system that archives data in real-time while minimizing the burden on the communication lines between the primary site and the storage facility.

### SUMMARY OF THE INVENTION

The present disclosure is directed to a storage architecture for mirroring data including a network and a primary storage system for serving storage requests. The primary storage system has a central processing unit and a random access memory operatively connected to the CPU. The random access memory is segmented into a parity cache for storing a difference between an old parity and a new parity of each data block until the difference is mirrored to a remote site. The storage architecture also includes a parity computation engine (that may be a part of a RAID controller if the underlying storage is a RAID) for determing the difference. A mirror storage system is in communication with the primary storage system via the network, wherein the mirror storage system provides a mirroring storage for the primary storage system for data recovery and business continuity.

The present disclosure is further directed to the mirror storage system having a CPU and a RAM segmented into a data cache, a mirroring cache, and a parity cache, and a parity computation engine.

Still another embodiment of the present disclosure is a method for asynchronous and real-time remote mirroring of data to a remote storage through a limited bandwidth network connection including the steps of calculating a difference between an old parity and a new parity of a data block being changed, mirroring the difference to the remote site whenever bandwidth is available, and generating new parity and, thereby, new data based upon the difference, old data and old parity data.

It is one object of the disclosure to leverage the fact that a RAID storage system performs parity computation on each write operation, by mirroring only the delta_parity to reduce the amount of data transferred over a network, making it possible to do real-time, asynchronous mirroring over limited bandwidth network connections.

It is another object of the disclosure to leverage RAID storage's parity computation on each write operation by mirroring only the difference of successive parities on a data block, e.g., a delta_parity. By mirroring only the delta_parity, the amount of data that needs to be transmitted over the network is efficiently reduced. It is another object of the disclosure to utilize the parity computation that is a necessary step in a RAID storage, therefore, little or no additional computation is needed to perform the parity mirroring at the primary storage side. As a benefit, performance of application servers in accessing the primary storage are not impacted by the mirroring process.

It is still another object of the disclosure to provide a system that can perform real-time, asynchronous mirroring over limited bandwidth network connections. It is a further object of the subject disclosure to provide an application and file system for archiving data that is system independent. Preferably, the application and file system has no significant impact upon application servers so that resources can be used efficiently.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings.

FIG. 1 is a somewhat schematic diagram of an environment utilizing an archiving method in accordance with the subject disclosure.

FIG. 2 is a block diagram of a storage server within the environment of FIG. 1.

FIG. 3 is a flowchart depicting a method for remotely replicating information in the environment of FIG. 1.

### DETAILED DESCRIPTION OF PREFERRED EMBODIMENTS

The present invention overcomes many of the prior art problems associated with remote replication of data. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

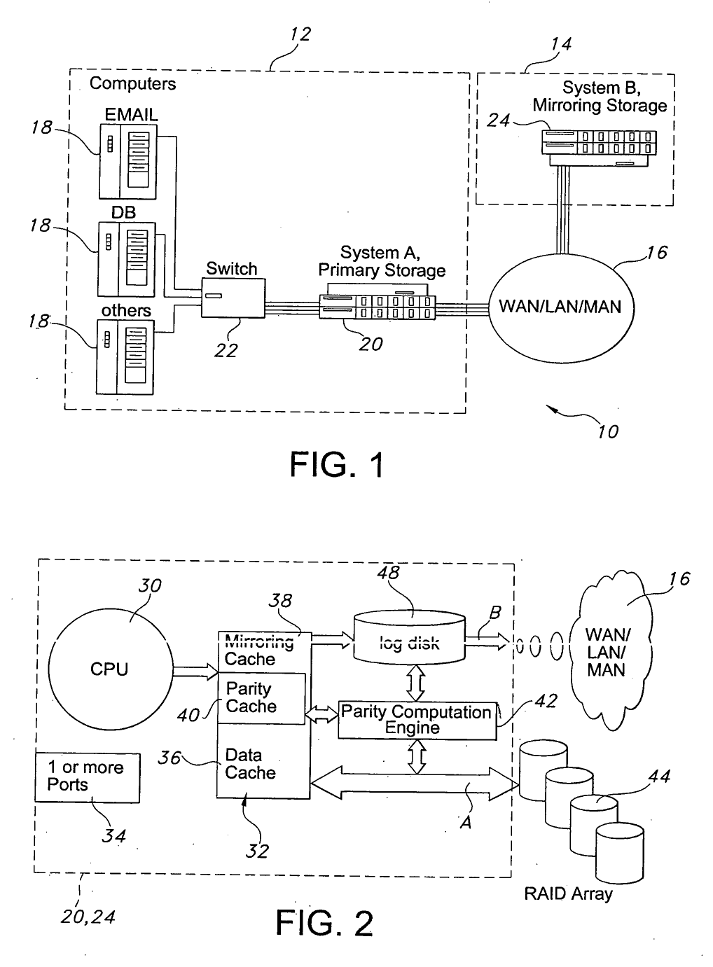

Referring now to the FIG. 1, there is shown a schematic diagram of an environment 10 that implements the archiving methodology of the present disclosure. The archiving methodology is a real-time, asychronous mirroring that is particularly useful over low bandwidth network connections. The following discussion describes the components of such a environment 10.

The environment 10 has a primary location 12 connected with a remote backup location 14 by a network 16. In the preferred embodiment, the network 16 is a low bandwidth WAN. The primary location 12 is a company or other entity that desires remote data replication. Preferably, the backup location 14 is distanced from the primary location 12 so that a single event would not typically impact operation at both locations 12, 14.

At the primary location 12, the company establishes a LAN/SAN with an Ethernet, Fibre Channel or the like architecture. The primary location 12 includes one or more servers 18 within the LAN/SAN for conducting the operations of the company. In a typical company, the servers 18 would provide electronic mail, information storage in databases, execute a plurality of software applications and the like. Company users interact with the servers 12 via client computers (not shown) in a well-known manner. In a preferred embodiment, the client computers include desktop computers, laptop computers, personal digital assistants, cellular telephones and the like.

The servers 18 communicate with a primary storage system 20 via an Ethernet/FC switch 22. For clarity, three servers 18 are shown but it is appreciated that any number of servers 18 may meet the needs of the company. The servers 18 are any of a number of servers known to those skilled in the art that are intended to be operably connected to a network so as to operably link to a plurality of clients, the primary storage system 20 and other desired components. The primary storage 20 is shared by the LAN as a data storage system, controller, appliance, concentrator and the like. The primary storage system 20 accepts storage requests from the servers 18, reads to and writes from the servers 18, serves storage requests and provides mirroring functionality in accordance with the subject disclosure.

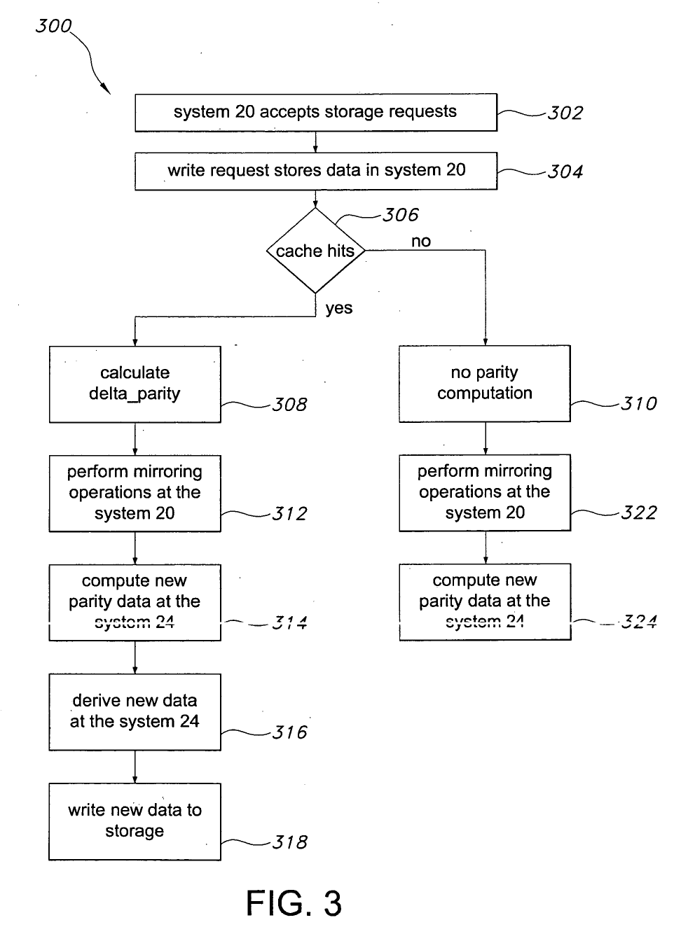

The primary storage system 20 communicates with mirror storage system 24 via the network 16. In order to maintain remote replication of the primary storage system 20, the primary storage system 20 sends mirroring packets to the mirror storage system 24. The mirroring storage system 24 provides an off site mirroring storage at block level for data recovery and business continuity. In a preferred embodiment, the mirror storage system 24 has a similar architecture to the primary storage system 20 but performs the inverse operations of receiving mirroring packets from the primary storage system 20. As discussed in more detail below with respect to FIG. 3, the mirror storage system 24 interprets the mirroring packets to remotely replicate the information on the primary storage system 20.

FIG. 2 illustrates an exemplary configuration of a storage unit system that is suitable for use as both the primary storage system 20 and mirror storage system 24. Each system 20, 24 typically includes a central processing unit (CPU) 30 including one or more microprocessors such as those manufactured by Intel or AMD in communication with random access memory (RAM) 32. Each system 20, 24 also includes mechanisms and structures for performing I/O operations such as, without limitation, a plurality of ports 34, network and otherwise. A storage medium (not explicitly shown) such as a magnetic hard disk drives within the system 20, 24 typically stores an operating system for execution on the CPU 30. The storage medium may also be used for general system operations such as storing data, client applications and the like utilized by various applications. For example, hard disk drives provide booting for the operating system, and paging and swapping between the hard disk drives and the RAM 32.

For the primary storage system 20 and the mirror storage system 24, the RAM 32 is segmented into three cache memories: a data cache 36, a mirroring cache 38, and a parity cache 40 as shown in FIG. 2. The data cache 36 performs as a traditional cache for data storage and transfer of data to the RAID array 44. The mirroring cache 38 and parity cache 40 are differently utilized as described in detail below. Each system 20, 24 also inlcudes a parity computation engine 42 in communication with the RAM 32 for conducting the necessary operations for the subject methodology. As denoted by arrows A, B, respectively, each system 20, 24 is operatively connected to a RAID array 44 and the network 16.

Referring now to FIG. 3, there is illustrated a flowchart 300 depicting a method for remotely replicating information across a low bandwidth WAN 16. During operation, storage unit system A accepts storage requests, read or writes from the computers that share the storage and serves these storage requests at step 302. At step 304, a write request occurs. In response to the write request, data is cached in two places, the mirroring cache 38 and the data cache 36 of storage unit system A.

At step 306, the parity computation engine 42 of the primary storage system 20 determines if the old data with the same logical block address (LBA) is in the mirroring cache 38 or the data cache 36 of storage unit system A (e.g., a cache hit). If a cache hit occurs, the method 300 proceeds to step 308. If not, the method proceeds to step 310.

At step 308, the parity computation engine 42 computes the new parity as is done in a RAID storage system. The delta_parity is the difference between the newly computed parity and the old parity or the difference between the new data and the old data of the same LBA. The delta_parity is stored in the parity cache 40 associated with the corresponding LBA.

Preferably, the parity computation engine 42 performs the same parity computation upon a write back or destaging operation between the data cache 36 and the underlying storage 44 (e.g., RAID array), wherein the parity cache 40 is updated accordingly by writing the new parity and the delta_parity thereto. Additionally, whenever the primary storage system 20 is idle, a background parity computation may be performed for changed or dirty blocks in the data cache 36, and the parity cache 40 can be updated accordingly by writing the new parity and the delta_parity to the parity cache 40.

At step 312, the primary storage system 20 performs mirroring operations. In a preferred embodiment, the mirroring operations are performed when the network bandwidth is available. The primary storage system 20 performs mirroring operations by looking up the parity cache using the LBAs of data blocks cached in the mirroring cache 38 and sending the delta_parity to the mirror storage system 24 if a cache hit occurs. If it is a cache miss, the data will be mirrored to the remote site. After mirroring the delta_parity/data, the method 300 proceeds to step 314 which occurs at the mirror storage system 24 where inverse operations as that of the primary storage system 20 are performed. At step 314, the mirror storage system 24 computes new parity data based upon the delta_parity/data received from the primary storage system 20.

At step 316, the mirror storage system 24 derives the new or changed data by using the input received from the primary storage system 20, the old data and the old parity existing in its data cache 36 and parity cache 40, or in its RAID array. The computation of the new data preferably uses the EX-OR function in either software or hardware. At step 318, the new data is written into the data cache 36 of the mirror storage system 24 according to its LBA and similarly the parity data is stored in the parity cache 40 according to its corresponding LBA.

At step 310, if the old data with the same LBA is not in the caches (e.g., a cache miss), the parity computation is done in the same way as in RAID storages. However, this computation may be delayed if the system is busy. If the parity compuation is done, the parity will be cached in the parity cache. At step 322, the primary storage system 20 performs mirroring operations sending the data in the mirroring cache 38 to the mirror storage system 24. At step 324, the mirror storage system 24 computes new parity data based upon the mirroring cache data received from the primary storage system 20.

In view of the above method 300, it can be seen that a write operation that does not change an entire block, can advantageously be mirrored to a mirror storage system 24 without transmitting a large amount of data, rather just the delta_parity is transmitted. This is a common occurrence such as in: banking transactions where only the balance attribute is changed among a block of information related to the customer such as name, SSN, address; a student record change in People Soft's academic transactions after the final exam, only the final grade attribute is changed while all other information regarding the student stays the same; addition or deletion of an item in an inventory database in a warehouse, only the quantity attribute is changed while all other information about the added/deleted product keeps the same; update a cell phone bill upon occurrence of every call placed; record a lottery number upon purchase; and a development project changes that adds to a large software package from time to time, these changes or additions represent a very small percentage of the total code space.

In these and like situations, the typical block size is between 4 kbytes and 128 kbytes but only a few bytes of the data block are changed. The delta_parity block contains only a few bytes of nonzero bits and all other bits are zeros so the delta_parity block can be simply and efficiently compressed and/or transferred. Typically, achievable traffic reductions can be 2 to 3 orders of magnitude without using complicated compression algorithms. For example, by just transferring the length of consecutive zero bits and the few nonzero bytes reflecting the change of the parity, substantial reductions in network traffic result. Moreoever, in RAID systems, the necessary computations are available so the method 300 incurs no or little additional overhead for mirroring purposes. Still further, by preferably using the parity cache 40, the mirroring process is also very fast compared to existing approaches.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation. While the invention has been described with respect to preferred embodiments, those skilled in the art will readily appreciate that various changes and/or modifications can be made to the invention without departing from the spirit or scope of the invention as defined by the appended claims.

What is claimed is:

1. A storage architecture for mirroring data comprising:
(a) a network;
(b) a primary storage system for serving storage requests, wherein the primary storage system has
i) a central processing unit (CPU),
ii) a random access memory (RAM) operatively connected to the CPU and segmented into a parity cache for storing a difference between an old parity and a new parity of each data block until the difference is mirrored to a remote site, and
iii) a parity computation engine for determing the difference; and
(c) a mirror storage system in communication with the primary storage system via the network, wherein the mirror storage system provides data mirroring storage for the primary storage system for data recovery and business continuity, wherein the mirror storage system stores a mirrored copy of data of the primary storage system that iscomputed based on the difference transferred from the primary storage system.

2. A storage architecture as recited in claim 1, wherein the primary storage system has the RAM further segmented into a data cache.

3. A storage architecture as recited in claim 1, wherein the primary storage system has the RAM further segmented into a mirroring cache.

4. A storage architecture as recited in claim 1, wherein the mirror storage system has a CPU, a RAM segmented into a data cache, a mirroring cache, and a parity cache, and a parity computation engine.

5. A computer-readable medium whose contents cause a computer system to perform a method for replicating, mirroring, and archiving data, the computer system having a CPU and a RAM with functions for invocation by performing the steps of:
calculating a delta_parity; and
providing the delta_parity to a mirror storage system.

6. A computer-readable medium as recited in claim 5 with functions for further invocation by performing the step of determining if a cache hit has occurred.

7. A computer-readable medium as recited in claim 5 with functions for further invocation by performing the steps of computing parity of a data based upon the delta_parity at the mirror storage system and deriving new data based upon the parity data.

8. A method for mirroring and archiving data comprising the steps of:
computing parity data based upon a delta_parity at a mirror storage system; and
deriving new data based upon the parity and existing data.

9. A method as recited in claim 8, further comprising the step of determining if a cache hit as occurred.

10. A method as recited in claim 8, further comprising the steps of:
calculating the delta_parity; and
providing the delta_parity to the mirror storage system.

11. A method as recited in claim 7, further comprising the step of applying data compression before the step of providing the delta_parity.

12. A method for asynchronous and real-time remote mirroring of data to a remote storage through a limited bandwidth network connection comprising the steps of:
calculating a difference between an old parity and a new parity of a data block being changed; and
mirroring the difference to the remote site whenever bandwidth is available.

13. A method as recited in claim 12, wherein calculating the difference is done by reading old data and the old parity, and performing an EX-OR with the changed data block.

14. A method as recited in claim 12, further comprising the step of generating new parity and, thereby, new data based upon the difference, old data and old parity data.

15. A system for storing data in a network comprising:
first means for calculating a delta_parity; and
second means for transmitting the delta_parity.

16. A system as recited in claim 15, wherein the first means is a parity computation engine.

17. A system as recited in claim 15, wherein the second means is limited bandwidth communication line.
